(19) United States
(12) Patent Application Publication
(10) Pub. No.: US 2012/0007782 A1
(43) Pub. Date: Jan. 12, 2012

(54) ANTENNA APPARATUS AND A WIRELESS COMMUNICATION APPARATUS

(75) Inventors: Masaki NISHIO, Kanagawa-ken (JP); Ippei Kashiwagi, Tokyo (JP)

(73) Assignee: KABUSHIKI KAISHA TOSHIBA, Tokyo (JP)

(21) Appl. No.: 13/025,568

(22) Filed: Feb. 11, 2011

(30) Foreign Application Priority Data
Jul. 6, 2010 (JP) 2010-154070

(51) Int. Cl. H01Q 1/38

(52) U.S. Cl. 343/700 MS

(57) ABSTRACT

An antenna apparatus comprises a ground board; a feeding portion for supplying electric power to the antenna apparatus, disposed on said ground board; a first line element having one end connected to said ground board, wherein a length from said feeding portion to an other end thereof is ¼ wave of resonance frequency; and a second line element having one end connected to said first line element, disposed along said first line element from the other end of said first line element, wherein a length from said feeding portion to an other end thereof is not k/12 (k is integer) wave of resonance frequency.

### CROSS-REFERENCE TO RELATED APPLICATION

This application is based upon and claims the benefit of priority from Japanese Patent Application No. P2010-154070, filed on Jul. 6, 2010; the entire contents of which are incorporated herein by reference.

### FIELD

Embodiments described herein generally relate to an antenna apparatus and a wireless communication apparatus.

### BACKGROUND

As technology for a broadband antenna apparatus, it is known that an antenna apparatus has a plurality of antenna element from which each length thereof differ, and further such antenna apparatus can resonate with a plurality of frequency by making a length of each antenna element into ¼ wave of the frequency to be resonated

In a conventional antenna apparatus, antenna elements are required for every frequency which is to resonate. For this reason, a number of elements and a length of the antenna have to be changed according to the resonance frequency, thus there is a problem that adjustment of band frequency is difficult.

### BRIEF DESCRIPTION OF THE DRAWINGS

FIG. 1 is a figure showing an antenna apparatus 100 concerning the 1st embodiment.

FIG. 2 is a figure showing principle of operation of the antenna apparatus 100 concerning the 1st embodiment.

FIG. 3 is a figure showing the principle of operation of the antenna apparatus 100 concerning the 1st embodiment.

FIG. 4 is a figure showing the principle of operation of the antenna apparatus 100 concerning the 1st embodiment.

FIG. 5 is a figure showing the principle of operation of the antenna apparatus 100 concerning the 1st embodiment.

FIG. 6 is a figure showing frequency changes of the antenna apparatus 100 concerning the 1st embodiment.

FIG. 7 is a figure showing an antenna apparatus 200 concerning the 2nd embodiment.

FIG. 8 is a figure showing frequency changes of an antenna apparatus 300 concerning the 3rd embodiment.

FIG. 9 is a figure showing the gross efficiency of the antenna apparatus 300 concerning the 3rd embodiment.

FIG. 10 is a figure showing the impedance of the antenna apparatus 300 concerning the 3rd embodiment.

FIG. 11 is a figure showing the impedance of the antenna apparatus 300 concerning the 3rd embodiment.

FIG. 12 is a figure showing the impedance of the antenna apparatus 300 concerning the 3rd embodiment.

FIG. 13 is a figure showing a relation between a fractional bandwidth and the gross efficiency for an antenna apparatus 300 of the 3rd embodiment.

FIG. 14 is a figure showing an antenna apparatus 400 concerning the 4th embodiment.

FIG. 15 is a figure showing an antenna apparatus 500 concerning the 5th embodiment.

FIG. 16 is a figure showing an antenna apparatus 600 concerning the 6th embodiment.

FIG. 17 is a figure showing an antenna apparatus 700 concerning the 7th embodiment.

FIG. 18 is a figure showing an antenna apparatus 800 concerning the 8th embodiment.

FIG. 19 is a figure showing an antenna apparatus 900 concerning the 9th embodiment.

FIG. 20 is a figure showing an wireless communication 1000 concerning the 10th embodiment.

FIG. 21 is a figure showing an wireless communication 1100 concerning the 11th embodiment.

### DETAILED DESCRIPTION

According to an embodiment of the invention, it is provided that an antenna apparatus including, a ground board; a feeding portion for supplying electric power to the antenna apparatus, disposed on said ground board; a first line element having one end connected to said ground board, wherein a length from said feeding portion to an other end thereof is ¼ wave of resonance frequency; and a second line element having one end connected to said first line element, disposed along said first line element from the other end of said first line element, wherein a length from said feeding portion to an other end thereof is not k/12 (k is integer) wave of resonance frequency.

According to an other embodiment of the invention, it is provided that an antenna apparatus including, a feeding portion for supplying electric power to the antenna apparatus, disposed on a ground board; a first line element having one end connected to said feeding portion; a second line element having one end connected to said first line element; and a capacity element for electrically connecting an other end of said first line element and an other end of said second line element; wherein a length from said feeding portion to said capacity element via said first line element is ¼ wave of resonance frequency.

According to an another embodiment of the invention, it is provided that a wireless communication including, a radio unit for generating signals from data; an antenna apparatus for transmitting the wireless signals generated by said radio unit, said antenna further includes, a ground board; a feeding portion for supplying electric power to the antenna apparatus, disposed on said ground board; a first line element having one end connected to said feeding portion, wherein a length from said feeding portion to an other end thereof is ¼*m (m is integer) wave of resonance frequency; a second line element having one end connected to said first line element; and a capacitance coupling means for coupling said first line element and said second line element.

Hereafter, embodiments are explained, referring to drawings.

### The 1st Embodiment

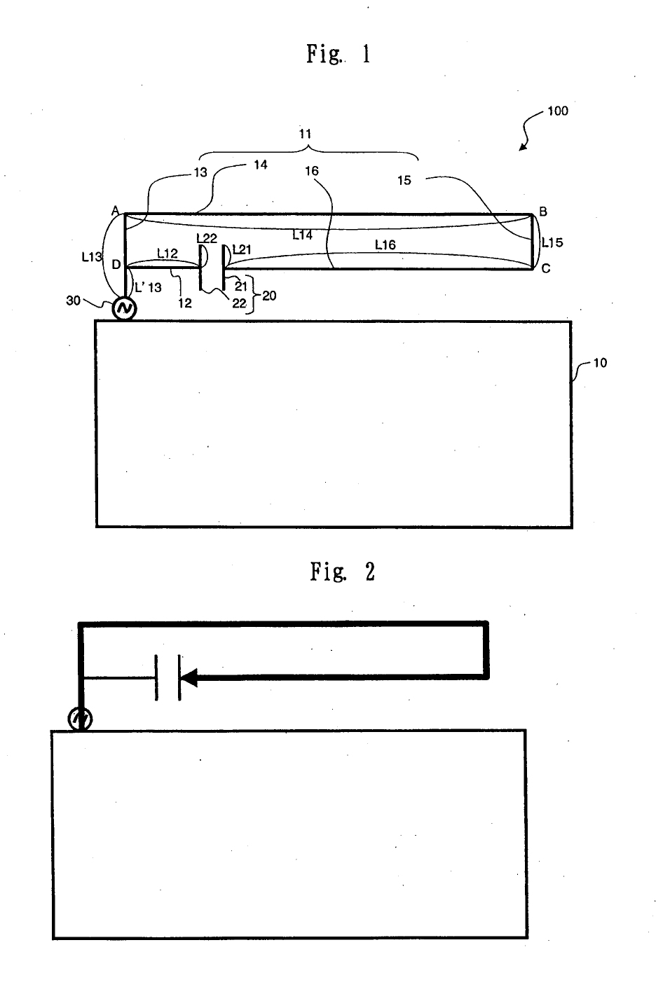

FIG. 1 is the figure showing an antenna apparatus 100 concerning the 1st embodiment of the present invention.

The antenna apparatus 100 is equipped with a ground board 10, a 1st line element 11 of which one end is connected to a ground board 10, a 2nd line element 12 of which one end is connected to the 1st line element 11, and a coupling element 20 which connects to the other end of the 1st line element 11 and the other end of the 2nd line element 12.

The ground board 10 comprises plain-like conductors with a limited size. The 1st line element 11 is an emitting element formed, for example, with conductors such as gold. In the example shown in FIG. 1, the 1st line element 11 comprise the 3rd line element 13 whose one end is connected to the ground board 10, being perpendicular to the ground board 10, the 4th line element 14 whose one end is connected to the other end of the 3rd line element, being parallel to the ground board 10, the 5th line element 15 whose one end is connected to the other end of the 4th line element, being perpendicular to the ground board 10 and the 6th line element 16 whose one end is connected to the other end of the 5th line element, whose the other end is connected to a coupling element 20, said 6th line element 16 being further parallel to the ground board 10.

Here, perpendicularity to the ground board 10 may mean that roughly perpendicularity to a certain plain which exists in the ground board 10 having a limited size or roughly perpendicularity to a part of a certain side which exists in the ground board 10. As for this embodiment, the 3rd line element 13 and the 5th line element 15 are perpendicularly located on a side of the ground board 10. As well, parallel to the ground board 10 may mean that roughly parallel to a certain plain which exists in the ground board 10 having a limited size or roughly parallel to a part of a certain side which exists in the ground board 10. As for this embodiment, the 4th line element 14 and the 6th line element 16 are parallel located on a side of the ground board 10.

The line element may be line-like shape, plate-like shape, pole-like shape and any shape for using an antenna. Also it may be partial thick or thin.

The 1st line element 11 has at least three bending portion A-C, for example. In the example shown in FIG. 1, the joint portion of the 3rd line element 13 and the 4th line element 14 is the 1st bending portion A. The joint portion of the 4th line element 14 and the 5th line element 15 is the 2nd bending portion B. The joint portion of the 5th line element 15 and the 6th line element is the 3rd bending portion C.

The joint area of the ground board 10 and the 1st line element 11 is called the feeding portion 30 which supplies electric power.

The 2nd line element 12 is an emitting element formed, for example, with conductors such as gold. In the example shown in FIG. 1, the one end of the 2nd line element 12 is connected to the 3rd line element 13, the other end of the 2nd line element 12 is connected to the coupling element 20, and the 2nd line element 11 is formed so that it may become parallel to the ground board 10.

The coupling element 20 comprises a capacitor, for example. It does not limit to the capacitor, but may contain any means for connecting with capacitance coupling. Such means for connecting with capacitance coupling includes means having substantially same way, means having same function and means having same result

For example, it may be two conductive materials spaced closely each other.

In the example shown in FIG. 1, the coupling element 20 has the 1st conductive element 21 connected to the 1st line element 11, and the 2nd conductive element 22 connected to the 2nd line element 12, which is located as parallel to this 1st conductive element

The antenna apparatus 100 is constituted so that the 1st distance L1 from the feeding portion 30 supplying electric power via the 1st line element 11 to the coupling element 20 may become ¼ wave of length of the 1st resonance frequency f1. In the example of FIG. 1, the sum (L11+L21) becomes ¼ wave of length of the 1st resonance frequency f1, said distance L11 is the length of the 1st line element 11, said distance L21 is the longest distance from the joint portion of 1st conductive element 21, jointing to the 1st line element 11, to the side or the edge portion of the 1st conductive element 21

The antenna apparatus 100 is constituted so that the 2nd distance L2 from the feeding portion 30 to the coupling element 20 via the 2nd line element 12 may be as length which is not k/12 (k is integer) wave length of the 1st resonance frequency f1.

In the example of FIG. 1, the sum (L′13+L12+L22) of the distance L′13 from the feeding portion 30 of the 1st line element 11 supplying electric power to the joint portion D with the 2nd line element 12, the element length L12 of the 2nd line element 12 and the longest element distance L22 from the joint portion jointing the second conductive element 22 with the 2nd line element 12 to the side or the edge portion of the 2nd conductive element 22, said sum is not k/12 (k is integer) wave length of the 1st resonance frequency f1.

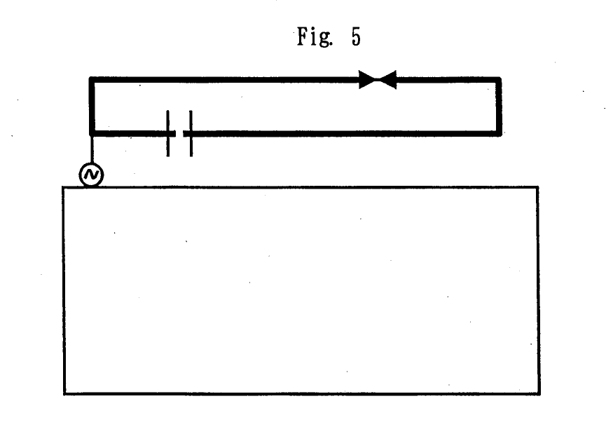

Hereafter, the principle of operation of the antenna apparatus 100 concerning this embodiment is explained by using FIG. 2 or FIG. 5. First, operation of the antenna apparatus when not considering influence of the coupling element 20 is explained. In this case, as shown in FIG. 2, the antenna apparatus 100 has the 1st series resonance mode that resonates with the 1st resonance frequency f1 that is made by the element length L11 of the 1st line element 11 as ¼ wave length.

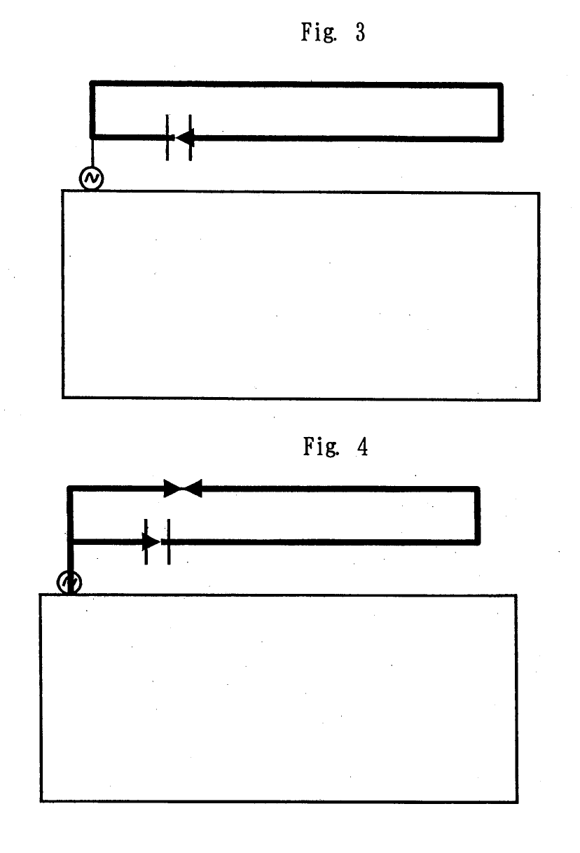

As shown in FIG. 3, the antenna apparatus 100 has the 1st parallel resonance mode that resonates with the 2nd resonance frequency f2 that is made by the length of the loop which consists of a part of 1st line element 11 and the 2nd line element 12 as ½ wave length.

Moreover, as shown in FIG. 4, the antenna apparatus 100 has the 2nd series resonance mode that resonates with the 3rd resonance frequency f3 that is made by the element length L11 of the 1st line element 11 as ¾ wave length.

As shown in FIG. 5, the antenna apparatus 100 has the 2nd parallel resonance mode that resonates with the 4th resonance frequency f4 that is made by the length of the loop which consists of a part of 1st line element 11 and the 2nd line element 12 as 1 wave length. In addition, the 1st-the 4th resonance frequency f1-f4 has the relation of f1<f2<f3<f4.

The input impedance of antenna apparatus 100 is set to about several dozens ohms at the time of the series resonance mode of the 1st and 2nd series resonance modes among the 1st and 2nd series resonance modes and the 1st and 2nd parallel resonance modes. The antenna apparatus 100 connects to the wireless communication apparatus (not shown) whose output impedance is 50 ohms, and can operate by the 1st and 3rd resonance frequency f1 and f3.

The antenna apparatus 100 resonates most strongly with the 1st resonance frequency f1, and if frequency becomes high, it will become difficult to resonate. If frequency approaches the 2nd resonance frequency f2, the antenna apparatus 100 will resonate easily. As described above although the antenna apparatus 100 resonates most easily with the 1st-the 4th resonance frequency f1-f4, it can resonate on other frequency in some degree, although it is not as much as to the above mentioned resonance frequency. With this embodiment, a bandwidth zone, where VSWR is less than a predetermined value around the 1st-the 4th resonance frequency f1-f4, is called as a bandwidth zone of the 1st-the 4th resonance frequency f1-f4. Said predetermined value is generally less than 3, although it depends on the wireless communication apparatus (not shown) having the antenna apparatus 100. Thereby, the antenna apparatus 100 can transmit and receive a radio signal. In another word, the wireless communications apparatus (not shown) having the antenna apparatus 100 can communicate within the bandwidth of the resonance frequency.

Although the above mentioned predetermined value is 3 as for this embodiment, it may be 4, 5 or other predetermined value, such value is properly determined by the specific device applied this antenna or the outside-circumstance where the device is used.

Also it may be less than 2 when the impedance miss matching loss is required to be smaller than 0.5 dB.

Next, the principle of operation of the antenna apparatus 100 at the time of considering the influence of the coupling element 20 is explained for each mode.

### (A) 1st Series Resonance Mode

When the antenna apparatus 100 is operating in the 1st series resonance mode shown in FIG. 2, the current which flows into the 1st line element 11 is large, but the current which flows into the 2nd line element 12 is small. Therefore, the concentration of the big electric charge at the 1st conductive element 21 connected to the 1st line element 11 and the 2nd conductive element 22 connected to the 2nd line element 12, does not take place, For this reason, the influence of the coupling element 20 at the antenna apparatus 100 is small, and the antenna apparatus 100 resonates with the 1st resonance frequency f1.

### (B) The 1st Parallel Resonance Mode

When the antenna apparatus 100 is operating by the 1st parallel resonance mode shown in FIG. 3, the jointing portion of the 1st line element 11 with the 1st conductive element 21 and the jointing portion of the 2nd line element 12 with the 2nd conductive element 22 serve as a current nodes, respectively. Moreover, since current flows into the antenna apparatus 100 so that the electric charge for reverse direction is accumulated in the 1st conductive element 21 and the 2nd conductive element 22, respectively, big potential difference arises in the 1st conductive element 21 and the 2nd conductive element 22. As a result, the electric charge which accumulates on the coupling element 20 increases. In this case, the influence of the coupling element 20 on the antenna apparatus 100 becomes large, and the antenna apparatus 100 resonates with the 2nd resonance frequency f′2 (f′2<f2) lower than the 2nd resonance frequency f2. In addition, the 2nd resonance frequency f′2 is determined by the capacity value of the coupling element 20.

### (C) 2nd Series Resonance Mode

When the antenna apparatus 100 is operating in the 2nd series resonance mode shown in FIG. 4, the antenna apparatus 100 resonates with the 3rd resonance frequency f3 that is made by the element length of the 1st line element 11 as ¾ wave length. Current flows also into the 2nd line element 12 at this time. Under the influence of the current which flows into the 2nd line element 12, potential difference arises in the 1st conductive element 21 and the 2nd conductive element 22. As a result, the electric charge which accumulates on the coupling element 20 increases. In this case, the influence of the coupling element 20 on the antenna apparatus 100 becomes large, and the antenna apparatus 100 resonates with the 3rd resonance frequency f′3 (f′3<f3) lower than the 3rd resonance frequency f3. In addition, the 3rd resonance frequency f′3 is determined by the capacity value of the coupling element 20.

Here, it is considered as the case that the 2nd distance L2 via the 2nd line element 12 from the feeding portion 30 supplying electric power to the coupling element 20 is k/12 (k is integer) wavelength of the 1st resonance frequency f1. In this case, the 2nd distance L2 is k/4 wavelength of the 3rd resonance frequency f3, and the 2nd line element 12 resonates with the 3rd resonance frequency f3. If an electric wave is emitted also from the 2nd line element 12 shorter than the 1st line element 11 in addition to the 1st line element 11, the radiant efficiency of the antenna apparatus 100 will deteriorate. So, at the antenna apparatus 100 concerning this embodiment, radiant efficiency degradation of the antenna apparatus 100 are suppressed by making the 2nd distance L2 into the length which is not k/12 wavelength of the 1st resonance frequency f1.

As long as the length is not k/12 wavelength of the 1st resonance frequency f1, the length may be any value. It may be preferable that the length is shorter than k/12 wavelength of the 1st resonance frequency f1, since in that case, the electric wave will riot induced strongly on the 2nd line element 12, and the radiation efficiency of the antenna apparatus 100 will be improved.

### (D) The 2nd Parallel Resonance Mode

When the antenna apparatus 100 is operating by the 2nd parallel resonance mode shown in the 5th figure, the antenna apparatus 100 resonates with the 4th resonance frequency f4 that is made by the length of the loop which consists of a part of 1st line element 11 and the 2nd line element 12 as one wavelength. At this time, the jointing portion of the 1st line element 11 and the 1st conductive element 21 and the jointing portion of the 2nd line element 12 and the 2nd conductive element 22 are served as a current node, respectively. Current flows into the antenna apparatus 100 so that the same electric charge is accumulated in the 1st conductive element 21 and the 2nd conductive element 22, respectively. Therefore, big potential difference does not arise in the 1st conductive element 21 and the 2nd conductive element 22. As a result, an electric charge hardly collects on the coupling element 20. Therefore, the influence of the coupling element 20 on the antenna apparatus 100 is small, and the antenna apparatus 100 resonates with the 4th resonance frequency f4.

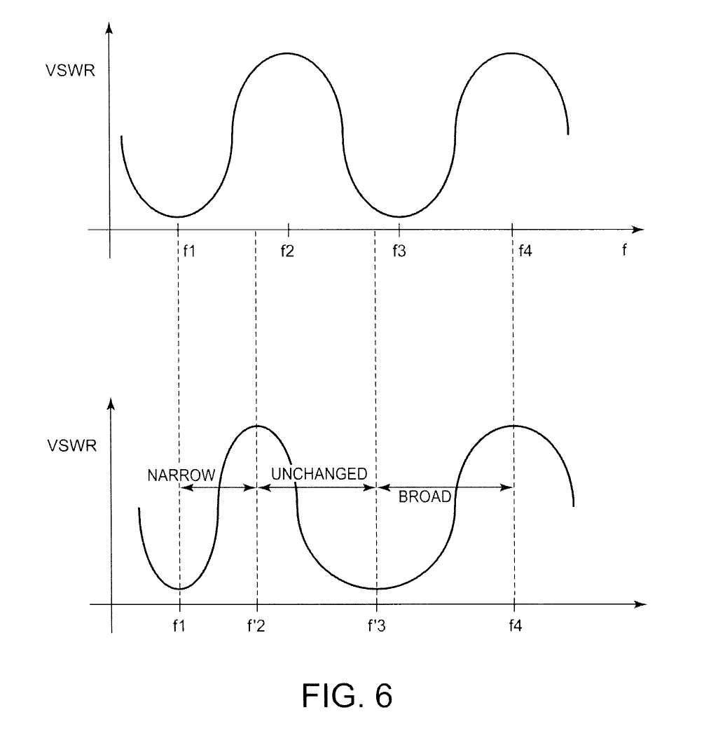

The above frequency change is explained by using FIG. 6. When the influence of the coupling element 20 is taken into consideration as shown in FIG. 6, the resonance frequency of the antenna apparatus 100 will change to f1-f4 to f1, f′2, f′3, and f4. The frequency intervals from f1 to f′2 become narrow, compared with the frequency intervals from f1 to f2. As a result, the bandwidth of the 1st resonance frequency f1 becomes narrow. The frequency intervals from f′2 to f′3 do not change, is as same as the frequency intervals from f2 to f3, and. However, the frequency intervals from f′3 to f4 become larger than the frequency intervals from f3 to f4. Consequently, the bandwidth of the 3rd resonance frequency f′3, compared with the 3rd resonance frequency f3, becomes large.

How narrow bandwidth the 1st resonance frequency can be, or how wide bandwidth the 3rd resonance frequency can be, will be determined by how low frequency f′2 and f′3, in short, it is determined by the capacity value of the capacity element 20.

As mentioned above, the antenna apparatus 100 concerning this embodiment, connects an end of 1st line element 11 having ¼ wavelength of the 1st resonance frequency f1 and an end of 2nd line element 12 via the coupling element 20. As a result, the antenna apparatus 100 can change the 2nd resonance frequency and the 3rd resonance frequency. Thereby, the bandwidth of the 1st and '3 resonance frequency can be changed. By adjusting the capacity value of the coupling element 20, the amount of change of the bandwidth regarding the 2nd resonance frequency f′2, 3rd resonance frequency f′3, and 1st resonance frequency f1, the 3rd resonance frequency f′3 can be adjustable.

As a result, the antenna apparatus 100 can resonates with two or more frequency, and a resonance frequency bandwidth can be easily adjusted only by adjusting the capacity value of the coupling element 20.

Furthermore, radiant efficiency degradation of the antenna apparatus 100 can be controlled by making distance (the 2nd distance L2) from the feeding portion 30 supplying electric power to the end of the 2nd line element 12 into the length which is not k12 wavelength of the 1st resonance frequency f1 (k is an integer).

### The 2nd Embodiment

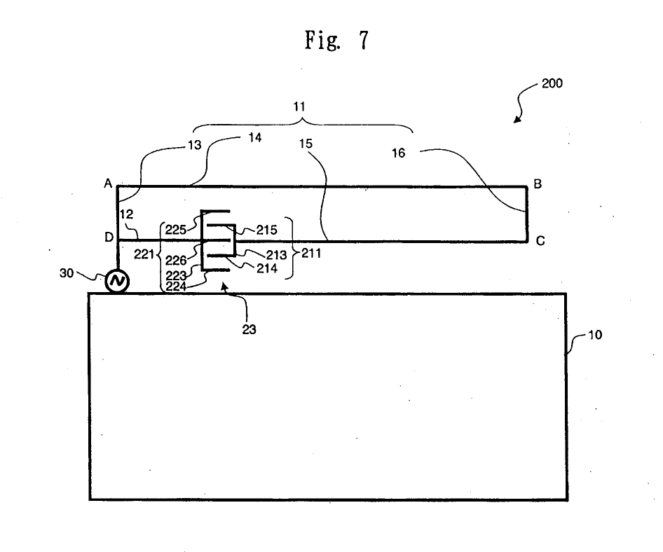

An antenna apparatus 200 concerning the 2nd embodiment of the present invention is explained by using FIG. 7. The antenna apparatus 200 concerning this embodiment makes the coupling element 20 of the antenna apparatus 100 shown in FIG. 1 to replace an interdigital capacitor 23. Since the configuration other than interdigital capacitor 23 is the same as the antenna apparatus 100 shown in FIG. 1, an explanation is abbreviated with giving same symbols and numbers.

The interdigital capacitor 23 is arranging so that the 1st conductive element 211 and the 2nd conductive element 221 shaped as comb-like may face each other, and it is the coupling element which is made to be enlarged the capacity value.

The 1st conductive element 211 of interdigital 23 as shown in FIG. 7 connects to other end of the 6th line element 16, said 1st conductive element 211 has the 13th conductive element 213 located perpendicularly to the 6th line element 6. Further, the 1st line element 211 may have the 14th conductive element 214, located perpendicularly at the 13th line element 213, which connects to one end of the 13th conductive element 213 and the 15th conductive element 215, located perpendicularly at the 13th conductive element 213, which connects to one end of the 13th line element 213. As not shown in figure, the antenna apparatus 200 may have the 16th line element 216, of which one end is connected to the 13th conductive element 213, located perpendicularly to the 13th conductive element 213, between the 14th, 15th conductive elements 214, 215. The 16th line element 216 may be plural.

The antenna apparatus 200 is constituted so that the 1st distance L1 from the feeding portion 30 supplying electric power via the 1st line element 11 to the interdigital capacitor 23 may become ¼ wave of length of the 1st resonance frequency f1. In the example of FIG. 7, the longest distance serves as the 1st distance L1 among the distances from the feeding portion 30 to the either end of the 13th-the 16th conductive element 213-216.

The 2nd conductive element 221 is connected to other end of the 2nd line element 2, said 2nd conductive element 221 has the 23rd conductive element 223 located perpendicularly to the 2nd line element 2. Further, the 2nd line element 221 may have the 24th conductive element 224, located perpendicularly at the 23rd line element 223, which is connected to one end of the 23rd conductive element 223 and the 25th conductive element 225, located perpendicularly at the 23rd conductive element 223, which is connected to one end of the 23rd line element 223. In addition, the antenna apparatus 200 may have the 26th line element 226, of which one end is connected to the 23rd conductive element 223, located perpendicularly to the 23rd conductive element 223, between the 24th, 25th conductive elements 224, 225. The 26th line element 226 may be plural, although a single as shown in the FIG. 7.

The antenna apparatus 200 is constituted so that the 2nd length L2, which is not k/12 (k is integer) wavelength of the 1st resonance frequency f1, from the feeding portion 30 to the interdigital capacitor 23 via the 2nd line element 12. In the example of FIG. 7, the longest distance serves as the 2nd distance L2 among the distances from the feeding portion 30 to the either end of the 23rd-the 26th conductive element 223-226.

The 14th and 15th conductive element 214 and 215 and the 24th-the 26th conductive element 224-226 are arranged by turns. In the example of FIG. 7, the 24th conductive element 224, the 14th conductive element 214, the 26th conductive element 226, the 15th conductive element 215, and the 25th conductive element 215 are disposed as an order near from the ground board 10.

In addition, since the principle of operation of the antenna apparatus 200 is the same as the antenna apparatus 100 of FIG. 1, explanation is omitted.

As mentioned above, the antenna apparatus 200 concerning this embodiment can realize a big capacity value in a small area by replacing a coupling element to the interdigital capacitor 23, while the same effect as the antenna apparatus 100 concerning the 1st embodiment is acquired.

### The 3rd Embodiment

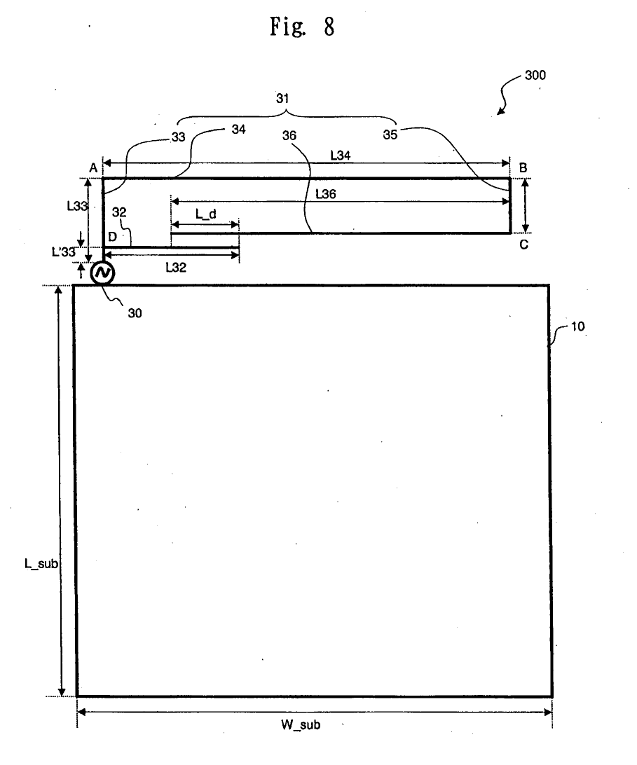

An antenna apparatus 300 concerning the 3rd embodiment of the present invention is explained by using FIG. 8. The antenna apparatus 300 as shown in FIG. 8 is the same configuration as the antenna apparatus 100 of FIG. 1 except not having the coupling element 20 and the length of the 1st and 2nd line element. By making the end of the 1st and 2nd line elements 11 and 12 to be overlapped, the antenna apparatus 300 concerning this embodiment can acquire the same effect as the coupling element 20, even if it does not have the coupling element 20.

Even if the end of the 1st and 2nd line elements 11 and 12 are not overlapped, it may be enough for achieving the effect of this embodiment that a portion of the 1st line element 11 and a portion of the 2nd line elements 12 are overlapped partially. The end of the 1st line element 11 may be folded or the end of 2nd line element 12 may be folded.

The antenna apparatus 300 includes the 1st line element 31, whose length from the feeding portion 30 to other end is ¼ wavelength of the 1st resonance frequency. And the antenna apparatus further includes the 2nd line element 32, whose one end is connected to the 1st line element 31, of which length from the feeding portion 30 to the other end is riot k/12 (k is integer) of the 1st resonance frequency, which is disposed along the 1st line element 31 from the end of the 1st line element 31.

The 1st line element 31 is a radiating element formed with conductors such as gold. The 1st line element 31 has at least three bending potion A-C as well as FIG. 1. In the example shown in FIG. 8, the 1st line element 31 is connected to the ground board 10 through the feeding portion 30 supplying electric power. The 1st line element 31 comprises the 3rd line element 33 disposed perpendicularly to the ground board 10, the 4th line element 34, disposed parallel to the ground board 10, whose one end is connected to the other end of the 3rd line element 33, the 5th line element 35, disposed perpendicularly to the ground board 10, whose one end is connected to the other end of the 4th line element 34 and the 6th line element 36 whose one end is connected to the other end of the 5th line element 35. The 6th line element 36 is arranged to be disposed along the 2nd line element 32 by the distance L_d from the other end.

The antenna apparatus 300 is constituted so that the 1st distance L31 from the feeding portion 30 supplying electric power to the end of the 1st line element 31 may become ¼ wave of length of the 1st resonance frequency f1. In the example of FIG. 8, the sum (L33+L34+L35+L36) of the element length of the 3rd-the 6th line elements 33-36 serves as the element length L31 of the 1st line element 31, and is ¼ wave of length of the 1st resonance frequency f1.

The 2nd line element 32 is a radiating element formed with conductors such as gold. In the example shown in FIG. 8, one end of the 2nd line element 32 is connected to the 3rd line element 33. And the 2nd line element 32 is located along the 6th line element 36 for the distance L_d from the other end.

The antenna apparatus 300 is constituted so that the 2nd distance L32 from the feeding portion 30 supplying electric power to the end of the 2nd line element 32 may serve as length which is not k/12 wavelength of the 1st resonance frequency f1. In the example of FIG. 8, the sum (L′33+L32) of the distance L′33 from the feeding portion 30 of the 1st line element 31 to the joint portion D and the element length L32 of the 2nd line element 32, said sum is not k/12 wavelength of the 1st resonance frequency f1.

The end of the 6th line element 36 of the 1st element 31 and the end of the 2nd line element 32 are disposed as parallel each other, for the distance L_d. According to this, the same effect is acquired as a case where the capacitor, which has the length of the 1st and 2nd conductive element is L_d, is connected at the end of the 1st and 2nd line elements 31 and 32.

In addition, when the end of the 1st and 2nd line elements 31 and 32 can be regarded as the coupling element 20, due to the same principle of operation of the antenna apparatus 300 as the principle of operation of the antenna apparatus 100, the explanation is omitted.

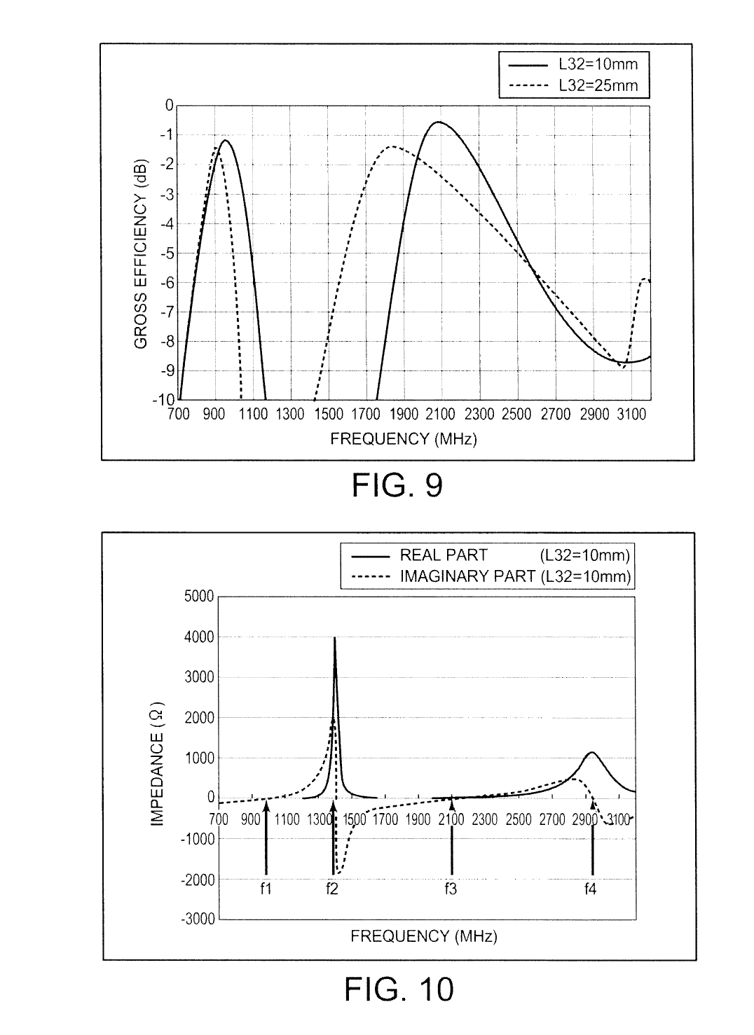

The gross efficiency of the antenna apparatus 300 is explained as shown in FIG. 9. The gross efficiency is the sum of the radiant efficiency of the antenna apparatus 300 and the mismatch loss. FIG. 9 is showing the gross efficiency of the antenna apparatus 300 in each frequency in case of the following:

Distance L′33=3.5 mm, which is from the feeding portion 30 of the 3rd line element supplying electric power to the joint portion D with the 2nd line element 32, an element length of the 3rd line element; L33=7.0 mm, an element length of the 4th line element 34; L34=42.5 mm, an element length of the 5th line element 35; L35=2.5 mm, an element length of the 6th line element 36; L36=40 mm, a size of the ground board 10; L_{——}sub×W_sub=112 mm×63 mm,

1. An element length L32 of the 2nd line element 32; L32=10 mm.

2. Distance L32=25. mm,

In addition, in the case of L32=10 mm, it is set to L_d=7.5 mm and the capacity value between 1st and 2nd line elements is set to 0.19 pF. In the case of L32=25 mm, it is set to L_d=22.5 mm, and the capacity value between 1st and 2nd line elements is set to 0.57 pF.

According to FIG. 9, when the element length L32 of the 2nd line element 32 is varied, namely, the capacity value between 1st and 2nd line elements is varied, it turns out that the resonance frequency band of the antenna apparatus 300 is changing.

The impedance of the antenna apparatus 300 in case of L32=10 mm is shown in FIG. 10. The solid line of FIG. 10 shows the real part of impedance, and a dotted line shows an imaginary part of impedance. According to FIG. 10, the antenna apparatus 300 resonates, when the 1st series resonance mode at the 1st resonance frequency f1=960 MHz; when the 1st parallel resonance mode at the 2nd resonance frequency f2=1410 MHz; when the 2nd series resonance mode at the 3rd resonance frequency f3=2090 MHz; when the 2nd parallel resonance mode at the 4th resonance frequency f4=2930 MHz.

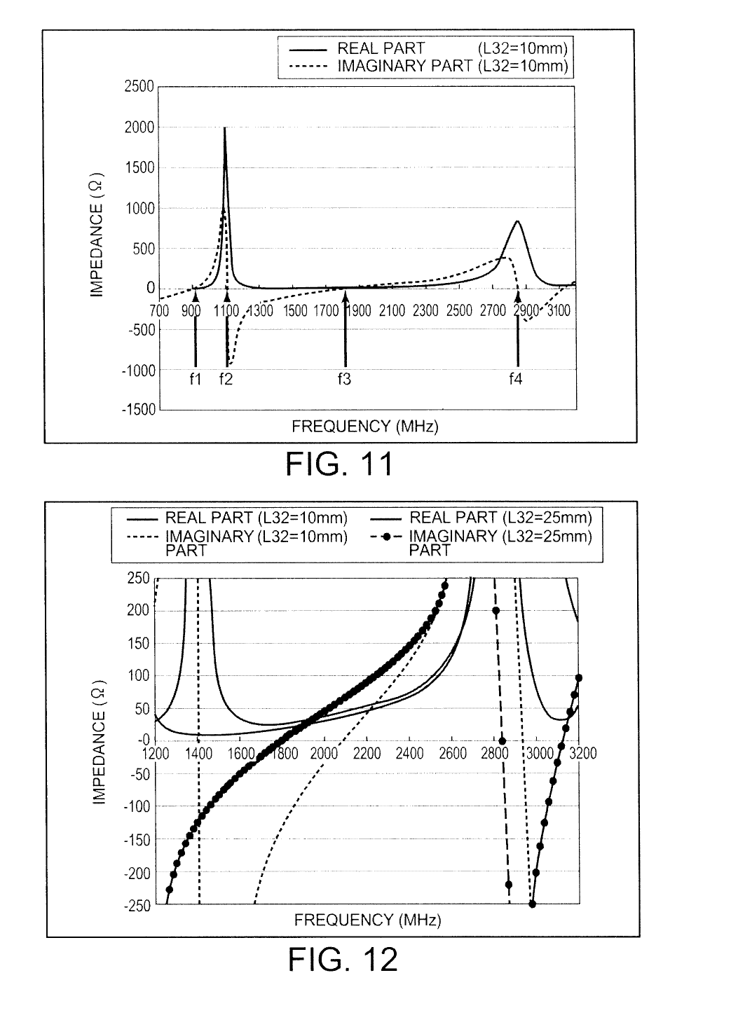

The impedance of the antenna apparatus 300 in case of L 32=25 mm is shown in FIG. 11. The solid line of FIG. 11 shows the real part of impedance, and a dotted line shows an imaginary part of impedance.

According to FIG. 11, the antenna apparatus 300 resonates, when the 1st series resonance mode at the 1st resonance frequency f1=910 MHz; when the 1st parallel resonance mode at the 2nd resonance frequency f2=1110 MHz; when the 2nd series resonance mode at the 3rd resonance frequency f3=1790 MHz; when the 2nd parallel resonance mode at the 4th resonance frequency f4=2830 MHz.

As explained in the 1st embodiment, two modes, the 1st parallel resonance mode and the 2nd series resonance mode, are affected more strongly by the influence of coupling between the 1st and 2nd line elements 31 and 32. As a result, the 2nd resonance frequency f2 and the 3rd resonance frequency f3 is made to be low frequency. The stronger the coupling between the 1st and 2nd line elements 31 and 32 is, in another word, the larger the capacity value is, the lower the 2nd and 3rd resonance frequency f2 and f3 are. As shown in FIG. 10 and FIG. 11, in this antenna apparatus 300, the length L32 of the 2nd line element 32 is changed to L32=25 mm from 10 mm. Thereby, the 1st resonance frequency f1 is made to be low frequency by 50 MHz, the 2nd resonance frequency f2 is made to be low frequency by 200 MHz, the 3rd resonance frequency f3 is made to be low frequency by 300 MHz, the 4th resonance frequency f4 is made to be low frequency by 100 MHz. It is understood that the 2nd and 3 resonance frequency f2 and f3 are greatly is made to be low frequency, compared with other resonance frequency.

The detail change of the impedance of the antenna apparatus 300 in L32=10 mm and 25 mm are shown in FIG. 12. FIG. 12 is a figure showing change of the impedance of the antenna apparatus 300 of the 2nd and 3 resonance frequency f2 and the f3, and its neighborhood frequency. Further, an enlarged part of FIG. 10 and FIG. 11 is overlapped. In FIG. 12, a thin solid line is the real part of impedance, a thin dotted line is the imaginary part in case of L32=10 mm. Moreover, a thick solid line shows the real part of the impedance and the thick dotted line shows the imaginary part in case of L32=25 mm.

Change of the imaginary part of the impedance in the case of moving from the 2nd resonance frequency f2 to the 3rd resonance frequency f3 is gradual in case of L32=25 mm, compared with the case of L32=10 mm, as shown in FIG. 6. Accordingly, the antenna apparatus 300 is made to be broadband greatly, in case of L32=25 mm, compared with the case of L32=10 mm.

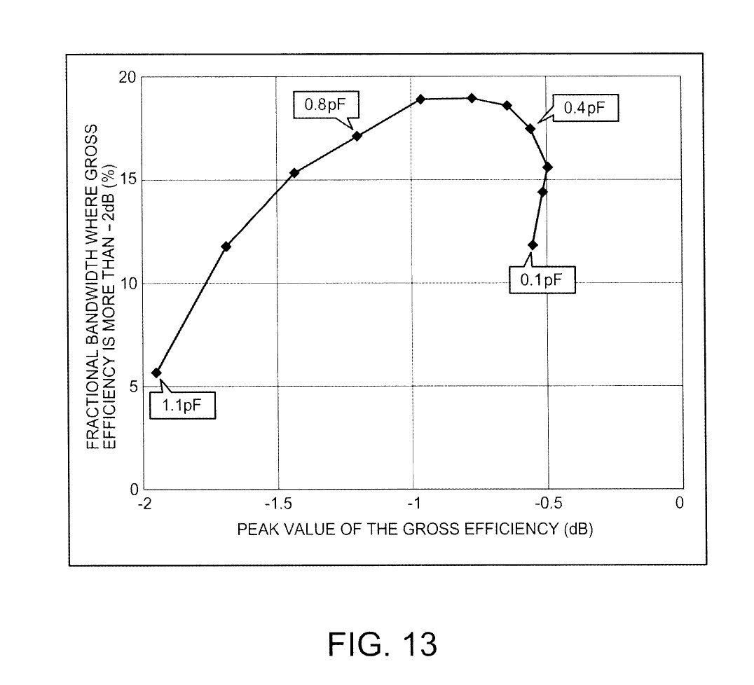

Next, by using FIG. 13, the relationship is explained, such relationship is between the peak value of the gross efficiency in the 3rd resonance frequency f3 of the antenna apparatus 300, the fractional bandwidth where the gross efficiency is more than −2 dB and the capacity value between lines of the 1st and 2nd line elements 31 and 32. As shown in FIG. 13, in case of lines interval capacity value C1=1.1 pF, the peak value of the gross efficiency and fractional bandwidth is the smallest. The bigger lines interval capacity value C1 is, the bigger the peak value of the gross efficiency and fractional bandwidth are. In contrast, when the lines interval capacity C1 becomes to be smaller than C1=0.7 pF, the fractional bandwidth begins to decrease, and when the lines interval capacity C1 becomes to be smaller than C1=0.3 pF, the peak value of the gross efficiency begins to decrease. Therefore, when the capacity value C1 between the 1st and 2nd line elements 31 and 32 is from 0.3 pF to 0.7 pF, the peak value of the gross efficiency or the fractional bandwidth can be made high. In particular, when the lines interval capacity C1 is C1=0.4 pF approximately, both of the peak value of the gross efficiency and the fractional bandwidth can be made high.

The capacity value C1 between the 1st and 2nd line elements 31 and 32 may be from 0.2 pF to 0.9 pF. The capacity value C1 will be determined to be lower of the above mentioned range in terms of the gross efficiency; in contrast, the capacity value C1 will be determined to be higher of the above mentioned range in terms of fractional bandwidth.

The lines interval capacity C1 is calculated by the formula (π*Lo*ε/1n ((D−r)/r). The detailed of this calculation is described in “YOKUWAKARUDENNJIKIGAKU” published by Ohm Co. ISBN: 9784274129797, Author: Hiroyuki Arai, Page 44-Page 45; contents of which are hereby incorporated by reference.

As mentioned above, the antenna apparatus 300 concerning this embodiment can achieve the same effect as one of the antenna apparatus 100 in FIG. 1. As well, the antenna apparatus 100 can reduce the number of parts by substituting the 1st and 2nd line element 31, 32 for the coupling element 20.

The antenna apparatus 300 can adjust the resonance frequency and the frequency bandwidth by changing the lines interval capacity value C1 between lines of the 1st and 2nd line elements 31 and 32. In order to make the peak of the gross efficiency and the fractional bandwidth to be high, it is better for the lines interval capacity value C1 between lines of the 1st and 2nd line elements 31 and 32 to be from 0.3 pF to 0.7 pF. Especially, it is further better to make the lines interval capacity value C1 to be 0.4 pF, if it is desirable that both of the fractional bandwidth and the peak of the gross efficiency are high. As mentioned above, the antenna apparatus 300 can easily acquire the desired peak value of gross efficiency and the fractional bandwidth only by changing the lines interval capacity value C1.

In addition, although this embodiment shows the example arranged from the direction near the ground board 10 in order of the 2nd line element 32 and the 4th line element 34, it may be arranged from the direction near the ground board 10 in order of the 4th line element 34 and the 2nd line element 32.

### The 4th Embodiment

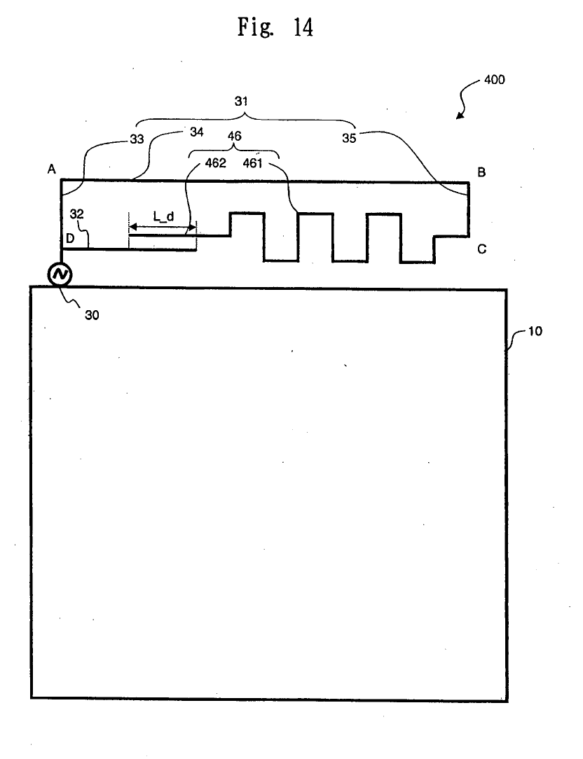

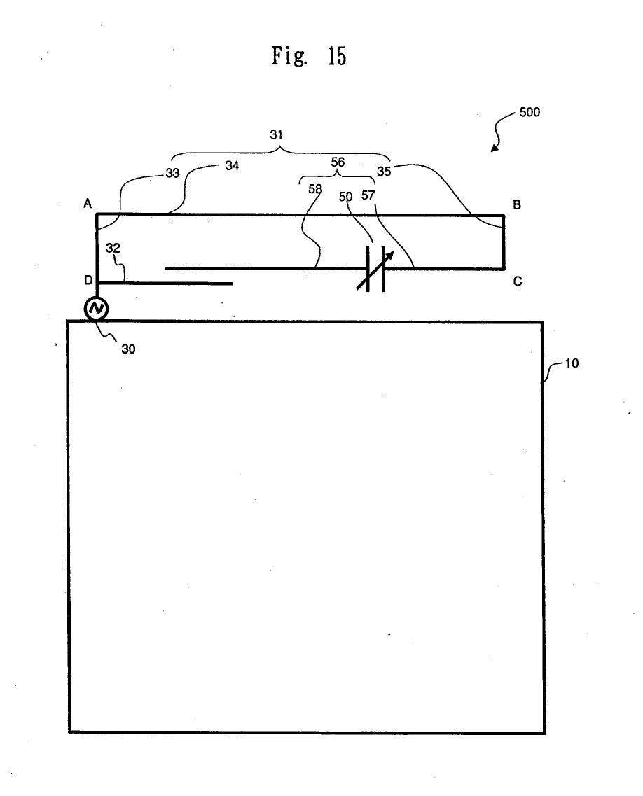

The antenna apparatus 400 concerning the 4th embodiment of the present invention is shown in FIG. 14. The antenna apparatus 400 as shown in FIG. 14 is the same configuration as the antenna apparatus 300 of FIG. 8 except that the part of the 6th line element 46 is meander shape. Therefore, an explanation is abbreviated with giving same symbols and numbers.

The 6th line element 46 shown in FIG. 14 includes a meander-like element 461 of which one end is connected to the other end of the 5th line element 35, and a straight-like element 462 of length LA of which one end is connected to the other end of the meander-like element 461. The straight-like element 462 is formed so that it may become parallel at a distance L_d from the other end of the 2nd line element 32.

Since the principle of operation of the antenna apparatus 400 is the same as the antenna apparatus 100 of FIG. 1, explanation is omitted.

The antenna apparatus 400 relating the 4th embodiment as mentioned above can downsize the antenna apparatus 400 by making a part of 6th line element 46 into meander. And the antenna apparatus 400 can achieve the same effect as the antenna apparatus 100 as shown in FIG. 1 or the antenna apparatus 300 of FIG. 8.

In addition, it may be constituted so that meander shape is formed in a part of either the 2nd-5th line elements 32-35 or two or more elements instead of the 6th line element 46.

### The 5th Embodiment

The antenna apparatus 500 concerning the 5th embodiment of the present invention is shown in FIG. 15. The antenna apparatus 500 as shown in FIG. 15 is the same configuration as the antenna apparatus 300 of FIG. 8 except that the 6th line element 46 has variable capacity element. Therefore, an explanation is abbreviated with giving same symbols and numbers.

The 6th line element 56 has a straight line-like 7th line element 57 of which one end is connected to the other end of the 5th line element 35, a variable capacity element connected to the other end of the 7th line element, and the straight line-like 8th line element 58 of which one end was connected to the variable capacity element 50. The 8th line element 58 is formed so that it may become parallel to the 2nd line element 32 at a distance Ld from the other end.

Since the electric length of the 1st line element 31 can be adjusted by disposing the variable capacity 50 in series on the 6th line element 57, the 1st resonance frequency f1 can be adjusted.

In addition, since the principle of operation of the antenna apparatus 500 is the same as the antenna apparatus 100 of FIG. 1, an explanation is omitted.

As mentioned above, the antenna apparatus 500 concerning this embodiment can achieve the same effect as the antenna apparatus 100 in FIG. 1 or the antenna apparatus 300 in FIG. 3. In addition, the antenna apparatus 500 can adjust from resonance frequency f1 to f4 by disposing the variable capacity element 50 in series in the 6th line element.

In addition, the variable capacity element 50 may be formed in either 3rd-the 5th line elements 33-35 and two or more elements, instead of the 6th line element 56.

### The 6th Embodiment

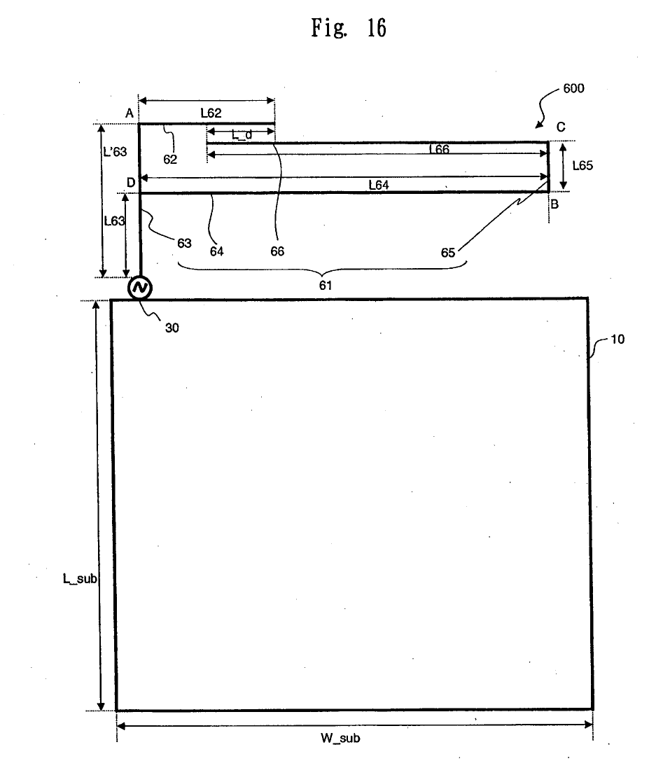

An antenna apparatus 600 concerning the 6th embodiment of the present invention is shown in FIG. 16. The antenna apparatus 600 regarding this embodiment is the same configuration as the antenna apparatus 300 of FIG. 8 except the disposition and the connections of the 2nd-6th line element 62-66. Therefore, an explanation is abbreviated with giving same symbols and numbers.

As for the 3rd line element 63, one end is connected with the ground board 10 through the feeding portion 30 supplying electric power. As for the 2nd line element 62, one end is connected to the other end of the 3rd line element 63. As for the 4th line element 64, one end is connected to the 3rd line element. As for the 5th line element 65, one end is connected to the other end of the 4th line element 64, and the 5th line element 65 is arranged so that it may become perpendicular to the ground board 10 in the direction which separates from the ground board 10. As for the 6th line element 66, one end is connected to the other end of the 5th line element 65.

The antenna apparatus 600 is constituted so that the 1st distance L61 from the feeding portion 30 supplying electric power to the end of the 1st line element 61 may become ¼ wave of length of the 1st resonance frequency fl. In the example of FIG. 16, the sum (L63+L64+L65+L66) of the length L63 from the feeding portion 30 of the 3rd line element 63 to the jointing portion with the 4th line element 64 and the element length of the 4th-the 6th line elements 64-66 becomes the element length L61 of the 1st line element 61. It becomes ¼ wave of length of the 1st resonance frequency f1.

As for the 2nd line element 62, one end is connected to the other end of the 3rd line element 63, and the 2nd line element 62 is arranged along the 6th line element 66 at only distance L_d from the other end.

The antenna apparatus 600 is constituted so that the 2nd distance from the feeding portion 30 to the end of the 2nd line element 62 may serve as length which is not k/12 wavelength of the 1st resonance frequency f1. In the example of FIG. 16, the sum (L′63+L62) of the element length L′63 of the 1st line element 61 and the element length L62 of the 2nd line element 62 is the length which is not k/12 wavelength of the 1st resonance frequency f1.

Although the antenna apparatus 300 shown in FIG. 8 is arranged from the direction near the ground board 10 in order of the 2nd line element 32 and the 4th line element 34, the antenna apparatus 600 concerning this embodiment can be arranged from the direction near the ground board 10 in order of the 4th line element 64 and the 2nd line element 62. This turn may be the order of the 2nd Line element 62 and the 4th line element 64 from the direction near the ground board 10. The other composition is the same composition as the antenna apparatus 300 shown in FIG. 8, and as well a principle of operation.

As mentioned above, according to the antenna apparatus 600 concerning this embodiment, even if it replaces an arrangement of the 2nd line element 62 and the 4th line element 64, the same effect as the antenna apparatus 100, 300 shown in FIG. 1 and FIG. 8 is acquired.

### The 7th Embodiment

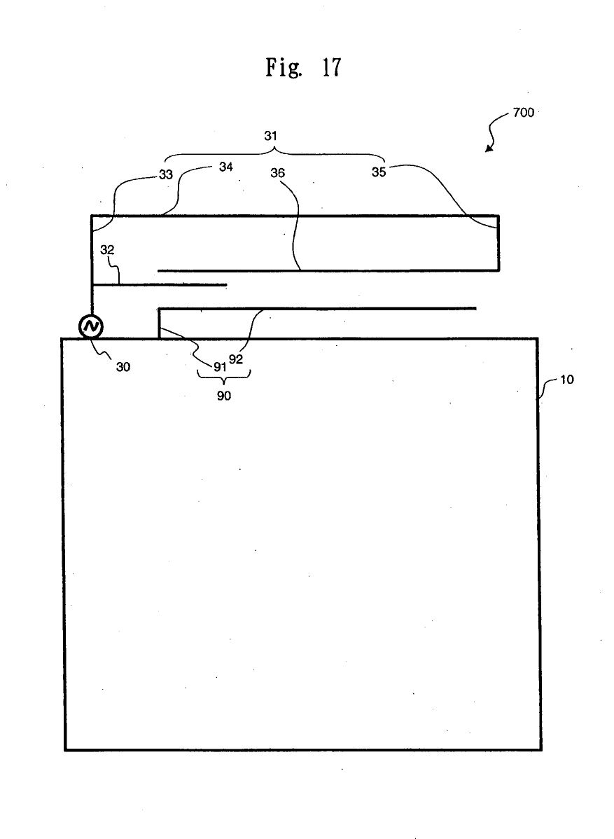

An antenna apparatus 700 concerning the 7th embodiment of the present invention is shown in FIG. 17. The antenna apparatus 700 regarding this embodiment is the same configuration as the antenna apparatus 300 of FIG. 8 except adding the 9th line element to the antenna apparatus 300. Therefore, an explanation is abbreviated with giving same symbols and numbers.

The antenna apparatus 700 shown in FIG. 17 is equipped with a L shape-like 9th line element 90. The 9th line element 90 comprises the line element 91 and the line element 92. The line element 91 whose one end is connected to neighborhood the ground board 10 of the feeding portion 30, is arranged as parallel to the 3rd line element 33. The line element 92 whose one end is connected to the other end of the line element 91, is arranged as parallel to the 2nd line element 32 and the 6th line element 36. In the example of FIG. 17, the line element 92 is formed between the 2nd line element 32 and the ground board 10.

The 9th line element 90 is a passive element unsupplied electric power. And if current flows into the 1st and 2nd line elements 31 and 32, current will flow also into the 9th line element 90 and it will emit an electric wave. By adjusting the element length of the 9th line element 90, the antenna apparatus 700 resonates with the 5th resonance frequency f5 other than the 1st-the 4th resonance frequency f1-f4.

In this embodiment, the connecting portion of the 9th elements to the ground board 10 is disposed in neighborhood the feeding portion 30 and under the each end of the 1st line element 31 and 2nd line element 32. In contrast, the connecting portion of the 9th elements to the ground board 10 may be disposed to be offset to the end of the 1st and 2nd line elements 31, 32.

As mentioned above, while the same effect as the antenna apparatus 100, 300 shown in FIG. 1 and FIG. 8 is acquired, the antenna apparatus 700 can increase the number of resonance frequency by forming the 9th line element 90 which is the passive element, and further more multiband is attained.

### The 8th Embodiment

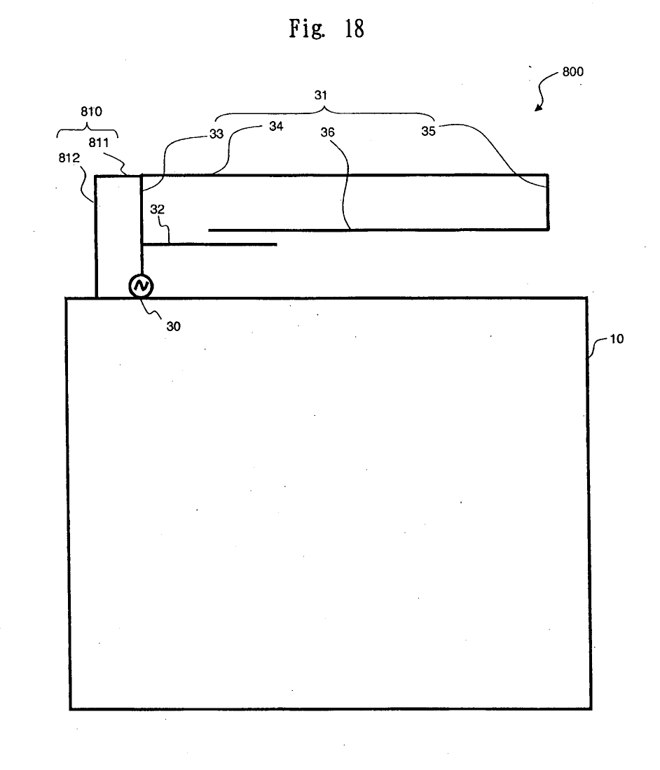

An antenna apparatus 800 concerning the 8th embodiment of the present invention is shown in FIG. 18. The antenna apparatus 800 regarding this embodiment is the same configuration as the antenna apparatus 300 of FIG. 8 except adding a 10th line element 810 to the antenna apparatus 300. Since other composition and principle of operation are the same as the antenna apparatus 300 of FIG. 8, an explanation is omitted.

As for the 10th line element 810, one end is connected to the other end of the 3rd line element 33, and the other end is connected to the ground board 10. In the example of FIG. 18, the 10th line element 810 comprises the line element 811 and the line element 812. The line element 811 whose one end connects to the other end of the 3rd line element 36, are disposed as parallel to the 6th line element. The line element 812, whose one end is connected to the other end of the line element 811 and whose other end is connected to the ground board 10, is disposed as the parallel to the 3rd line element 33.

Thus, the antenna apparatus 800 can be formed into high impedance by forming the 10th line element 810 which is a short circuiting element in the antenna apparatus 800.

### The 9th Embodiment

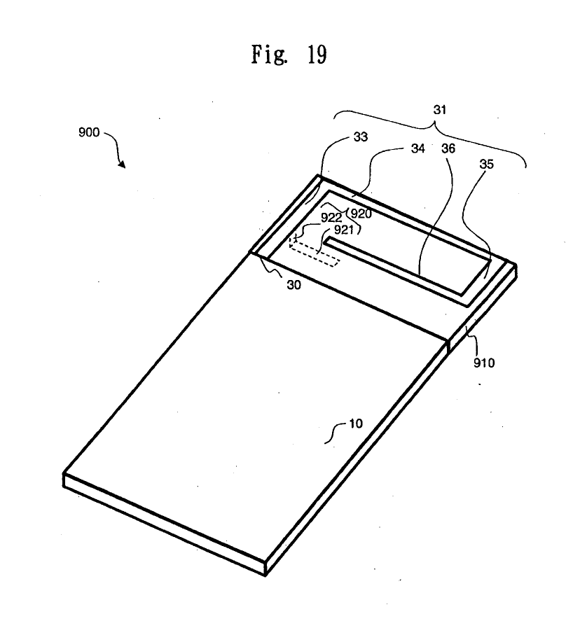

An antenna apparatus 900 relating to the 9th embodiment of the present invention by using FIG. 19 is explained. This embodiment shows the example in the case of mounting the antenna apparatus 300 shown in FIG. 8 by using a micro strip line. The antenna apparatus 900 is same composition as the antenna apparatus 300 shown in FIG. 8 except for the composition of the 2nd line element 920, therefore, an explanation is omitted, because of the same composition, and a principle of operation.

The antenna apparatus 900 has the dielectric substrate 910. The ground board 10 is formed on one surface of the dielectric substrate 910. The 1st line element 31 is formed on the same surface on which the ground board 10 of the dielectric substrate 910 is formed. The 1st line element 31 comprises micro strip lines. As shown in FIG. 19, it ma be constituted so that the 3rd-the 6th line elements 33-36 of the 1st line element 31 may be as one micro strip line.

The 2nd line element 920 comprises a line element 921 formed on the opposite surface on which the ground board 10 of the dielectric substrate 910 is formed and a via hole 922 for connecting the line element 921 and the 3rd line element 33. The line element 921 is constituted as micro strip lines, and being parallel to the 6th line element 36 at distance L_d from the other end.

As mentioned above, as for the antenna apparatus 900 concerning the 9th embodiment, the same effect as the antenna apparatus 100 and 300 shown in FIG. 1 and FIG. 3 is acquired. By arranging the dielectric substrate 910 between the 2nd line element 920 and the 6th line element 36 as parallel, the distance from the ground board 10 to the 2nd line element 920 or the 6th line element 36 can be made equal. Thereby, the antenna apparatus 900 can be made to be low.

In addition, the substrate of a magnetic body may be used instead of the dielectric substrate 910. The antenna apparatus 100, 200, 400-800 shown in the 1st, 2 and the 4th-the 8th embodiment can also be mounted by using the micro strip line.

### The 10th Embodiment

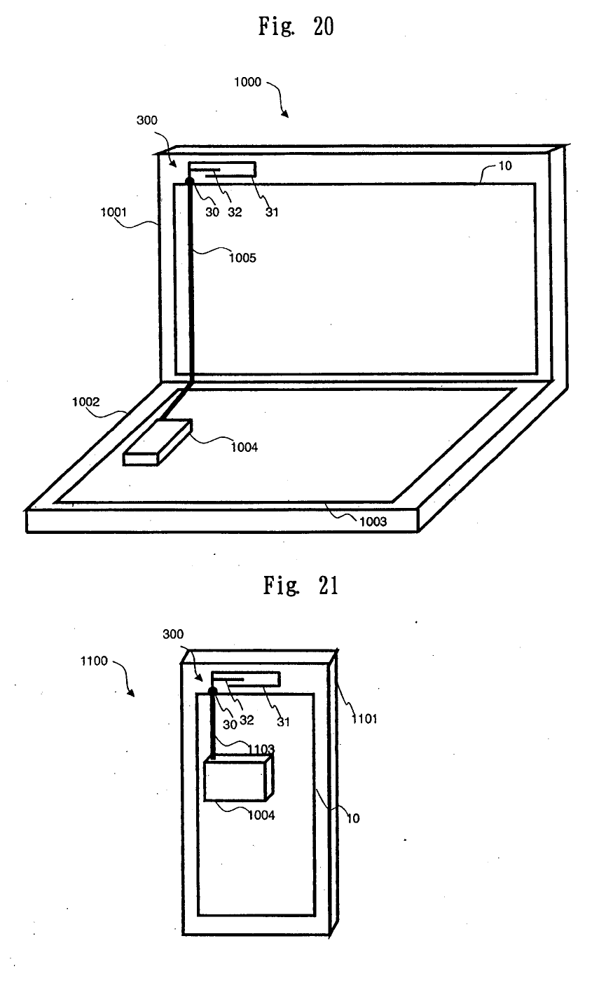

An wireless communication apparatus 1000 relating the 10th embodiment of the present invention shown in FIG. 20 is explained. This embodiment explains the example which applied the antenna apparatus 300 of FIG. 8 to the wireless communication apparatus 1000.

The wireless communication apparatus 1000 of FIG. 20 is folded up, for example like a notebook PC, and is equipment which can be carried. The wireless communication apparatus 1000 has the 1st case 1001 having a liquid crystals display etc. (not illustrated), and the 2nd case 1002 having a keyboard etc. (not illustrate). Furthermore, the wireless communication apparatus 1000 has the antenna apparatus 300 shown in FIG. 8 in the 1st case 1001 inside, a ground board 1003 in the 2nd case 1002 inside and a radio unit 1004 formed on the ground board 1003. The feeding portion 30 of the radio part 1004 and the antenna apparatus 300 are connected on a coaxial line 1005.

The radio unit 1004 makes signal processing of the transmitted data from the higher layer (not illustrated), and generates transmitting signals. The radio unit 1004 transmits the generated signal through the antenna apparatus 300.

The radio portion 1004 makes signal processing of the wireless data received from the antenna apparatus 300 and generates received data. The radio unit 1004 transmits the generated signal to the higher layer (not illustrated).

As mentioned above, the wireless communication 1000, for example, such as a notebook PC etc. is equipped with the antenna apparatus 300 as shown in the FIG. 8. Thereby, it is realizable that the wireless apparatus 1100 equipped with the antenna apparatus which can easily adjust the resonance frequency. Moreover, it is also possible to be mounted in the wireless communication which is not carried like disk top PC or television except a notebook PC.

### The 11th Embodiment

A wireless communication 1100 relating the 11th embodiment of the present invention by using FIG. 21 is explained. In this embodiment, the example which applied the antenna apparatus 300 of FIG. 8 to the wireless communication 1100 is explained.

The wireless communication apparatus 1100 of FIG. 20 is equipment which can be carried, for example, like a mobile terminal. The wireless communication 1100 has a case 1101 having liquid crystals displays etc (not illustrated). Furthermore, the wireless communication 1100 has the antenna apparatus 300 in the case 1101 inside and the radio unit 1004 formed on one surface of the ground board 10. The feeding portion 30 of the antenna apparatus 300 and the radio part 1004 are connected on a coaxial line 1103.

Since operation of the wireless communication apparatus 1100 is the same as the wireless communication apparatus 1000 of FIG. 20, an explanation is omitted.

As mentioned above, the antenna apparatus 300 can be mounted on a small wireless communication apparatus such as a mobile terminal, for example, besides a notebook PC. In this embodiment, the antenna apparatus 300 is arranged to be parallel to the ground board 10, however, it may be arranged to be vertical to the ground board 10, on the top side of the case 1101. Thereby, it is achieved to make impedance higher.

Further, in this embodiment, the feeding portion 30 is disposed on the neighborhood edge of the ground board 10, in contrast, it may be disposed on around the center of the ground board 10 edge. Compared to the feeding portion's allocation at the center, the feeding portion's allocation at the edge gives good property of the antenna apparatus 300, because current paths occur in both sides on the edge of the ground board 10 from the feeding portion 30 in case of the feeding portion's allocation at the center.

Still more, although in the 10th and 11th embodiment, that the antenna apparatus 300 of FIG. 8 is mounted in the wireless communication 1000-1100 as an example, is explained, the antenna apparatus 100, 200, 400-900 shown in FIG. 1, FIG. 7, FIG. 14-FIG. 19 may be mounted.

In addition, in this embodiments, a length from the feeding portion 30 to the capacity element via the first line element is ¼ wave of resonance frequency, however, it may be ¼*m (m is integer) wave of resonance frequency.

While certain embodiments have been described, these embodiments have been presented by way of example only, and are not intended to limit the scope of the inventions. Indeed, the novel methods and systems described herein may be embodied in a variety of the other forms; furthermore, various omissions, substitutions and changes in the form the methods and systems described herein may be made without departing from the sprit of the inventions. The accompanying claims and their equivalents are intended to cover such forms or modifications as would fall within the scope and spirit of the inventions.

What is claim is:

1. An antenna apparatus comprising;
a ground board;
a feeding portion for supplying electric power to the antenna apparatus, disposed on said ground board;
a first line element having one end connected to said ground board, wherein a length from said feeding portion to an other end thereof is ¼ wave of resonance frequency; and
a second line element having one end connected to said first line element, disposed along said first line element from the other end of said first line element, wherein a length from said feeding portion to an other end thereof is not k/12 (k is integer) wave of resonance frequency.

2. The antenna apparatus as set forth in claim 1:
wherein said second line element disposed to be parallel to said first line element for a predetermined distance D from the other end of said first line element.

3. The antenna apparatus as set forth in claim 2:
wherein said antenna apparatus resonates with the second resonance frequency f2 (2*f1<f2<3*f1 and f1 is said resonance frequency) determined by a capacity (π*Lo*ε/1n ((D−r)/r))) from said first line element and said second line element, when a width of a line is r, a length is a line is Lo and dielectric constant between lines is ε, wherein the lines are disposed to parallel said first line element with said second line element each other.

4. The antenna apparatus as set forth in claim 3:
wherein said capacity is 0.3 p<π*Lo*ε/1n ((D−r)/r<0.7 p.

5. The antenna apparatus as set forth in claim 1:
wherein said first line element has 3 bending portions.

6. The antenna apparatus as set forth in claim 5:
wherein said first line element further includes,
a third line element having one end connected to said feeding portion, disposed to be perpendicular to said ground board;
a forth line element having one end connected to an other end of the third line element, disposed to be parallel to said ground board;
a fifth line element having one end connected to an other end of the forth line element, disposed to be perpendicular to said ground board and; and
a sixth line element having one end connected to an other end of fifth line element, disposed to be parallel to said ground board.

7. The antenna apparatus as set forth in claim 6:
wherein the one end of said second line element is connected to said third line element.

8. The antenna apparatus as set forth in claim 6:
wherein said sixth line element is meander shape.

9. The antenna apparatus as set forth in claim 6:
wherein said sixth line element includes a variable capacity element.

10. The antenna apparatus as set forth in claim 6 further comprising:
a seventh line element of which one end is connected to said third line element, of which an other end is connected to said ground board.

11. The antenna apparatus as set forth in claim 6 further comprising:
an eighth line element of which one end is connected to said ground board, dispose to be parallel to said third line element; and,
a ninth line element of which one end is connected to an other end of said eighth line element, disposed to be parallel to said second line element and said sixth line element.

12. An antenna apparatus comprising;
a feeding portion for supplying electric power to the antenna apparatus, disposed on a ground board;
a first line element having one end connected to said feeding portion;
a second line element having one end connected to said first line element; and
a capacity element for electrically connecting an other end of said first line element and an other end of said second line element;
wherein a length from said feeding portion to said capacity element via said first line element is ¼ wave of resonance frequency.

13. An antenna apparatus as set forth in claim 12:
wherein said capacity element is as interdigital capacity element, shaped as comb-like.

14. An antenna apparatus as set forth in claim 12:
wherein a length from said feeding portion to said capacity element via said second line element is not k/12 (k is integer) wave of resonance frequency.

15. A wireless communication apparatus for communicating a wireless signal comprising;
a radio unit for generating signals from data;
an antenna apparatus for transmitting the wireless signals generated by said radio unit, said antenna further includes,
a ground board;
a feeding portion for supplying electric power to the antenna apparatus, disposed on said ground board;
a first line element having one end connected to said feeding portion, wherein a length from said feeding portion to an other end thereof is ¼*m (m is integer) wave of resonance frequency;
a second line element having one end connected to said first line element; and
a capacitance coupling means for coupling said first line element and said second line element.

16. The wireless communication apparatus as set forth in claim 15:
wherein a portion of said second line element is disposed along a portion of said first line element.

17. The wireless communication apparatus as set forth in claim 15:
wherein the other end of said first line element electrically couples to said second line element and an other end of said second line element electrically couples to said first line element.

18. The wireless communication apparatus as set forth in claim 15:
wherein said antenna apparatus further comprises a first series resonance mode that resonates with a first resonance frequency f1 that is made by the element length of said first line element as ¼ wave length and a second series resonance mode that resonates with a third resonance frequency f3 that is made by the element length of said first line element as ¾ wave length.

19. The wireless communication apparatus as set forth in claim 15:
wherein a length from said feeding portion to said capacity element via said second line element is not k/12 (k is integer) wave of resonance frequency.

20. The wireless communication apparatus as set forth in claim 19:
wherein a capacity value of said capacitance coupling means is from 0.3 pF to 0.7 pF.
